(19) United States
(12) Patent Application Publication
(10) Pub. No.: US 2019/0164532 A1
(43) Pub. Date: May 30, 2019

(54) DIGITAL ELECTROACOUSTIC TRANSDUCER APPARATUS

(71) Applicant: AUDIO-TECHNICA CORPORATION, Tokyo (JP)

(72) Inventors: Toyokazu EGUCHI, Tokyo (JP); Kenzo TSUIHIJI, Suita-shi (JP)

(21) Appl. No.: 16/104,293

(22) Filed: Aug. 17, 2018

(30) Foreign Application Priority Data
Nov. 30, 2017 (JP) 2017-230160

(51) Int. Cl. G10K 11/178; H04R 9/06; H04R 9/04

(52) U.S. Cl. CPC G10K 11/17823; G10K 11/17853; H04R 9/06; H04R 9/046; G10K 2210/3027; G10K 2210/3046; G10K 2210/3044; G10K 2210/3028; G10K 2210/3026; G10K 2210/1081

(57) ABSTRACT

A digital electroacoustic transducer apparatus according to the present invention includes: a signal processing circuit that generates a digital processing signal based on a digital signal from a sound source; a first drive unit that receives the digital processing signal; a sound pickup unit that picks up noise and generates a noise signal; a noise canceling circuit that generates a cancel signal based on the noise signal; and a second drive unit that receives the cancel signal, thereby reducing a difference between the phase of the cancel signal and the phase opposite to that of noise.

### TECHNICAL FIELD

The present invention relates to a digital electroacoustic transducer apparatus.

### BACKGROUND ART

In recent years, musical sound reproducing apparatuses having a function of outputting audio signals as digital signals have been widely adopted. A digital signal from such a musical sound reproducing apparatus is converted to sound waves, for example, by an electro-acoustic transducer (hereinafter referred to as “digital electroacoustic transducer apparatus”) that can output desired sound waves according to a digital signal (see Japanese Patent Laid-Open No. 2015-065661, for example).

Examples of such digital electroacoustic transducer apparatus include speakers installed indoors, and earphones and headphones worn over a user's ears (head).

The digital electroacoustic transducer apparatus includes a dynamic drive unit and a signal processing circuit for generating processing signals based on digital signals from a sound source. The drive unit includes a diaphragm and a plurality of voice coils. Each voice coil is driven with a processing signal generated in the signal processing circuit. Consequently, the digital electroacoustic transducer apparatus efficiently generates sound at high to low frequencies based on audio signals.

A known electrocoustic transducer apparatus that converts audio signals to sound waves includes a system for canceling noise in the external environment (hereinafter referred to as an “NC system”).

An electroacoustic transducer apparatus including the NC system includes a microphone and a noise canceling circuit (hereinafter referred to as an “NC circuit”). The microphone picks up noise around the electroacoustic transducer apparatus and generates a noise signal. The NC circuit generates a cancel signal according to the noise signal generated by the microphone. The cancel signal is a signal acoustically opposite in phase to the noise signal. The electroacoustic transducer apparatus generates sound waves based on a synthesized signal generated by synthesizing the cancel signal and an audio signal. Consequently, noise is acoustically canceled out with sound waves generated based on the synthesized signal through the electro-acoustic transducer, and is thus canceled.

When such an NC system is mounted in a digital electroacoustic transducer apparatus, signal processing, such as generation of a cancel signal and synthesis of a cancel signal and an audio signal, is executed, for example, through digital processing using a digital signal processor (DSP) (see Japanese Patent Laid-Open No. 2017-098993).

The NC system disclosed in Japanese Patent Laid-Open No. 2017-098993 executes generation of a cancel signal and generation of a synthesized signal through a single DSP. Therefore, the NC system can generate an appropriate cancel signal depending on the type of noise.

Generating a cancel signal through digital processing using a DSP increases the time required for generating the cancel signal according to the amount of computation in the DSP to delay in time. Consequently, the phase of the cancel signal is not opposite to the phase of noise to be canceled, and is delayed by a phase corresponding to the time delayed with respect to the phase opposite to that of the noise, causing a phase difference between the cancel signal and the phase opposite to that of the noise.

In addition, when a synthesized signal is generated by digital processing using an adder circuit (mixer) included in the DSP, the phase of the synthesized signal (cancel signal) varies depending on the phase characteristics of the adder circuit. Consequently, the phase of the cancel signal is not opposite to the phase of the noise to be canceled but is shifted by the phase change from the opposite phase, causing a phase difference between the cancel signal and the phase opposite to that of noise.

Thus, if a phase difference occurs between the cancel signal and the phase opposite to that of the noise, the cancel signal cannot cancel the noise sufficiently by canceling it out.

### SUMMARY OF THE INVENTION

An object of the present invention, which has been made to solve such a conventional problem, is to provide a digital electroacoustic transducer apparatus including an NC system with a reduced phase difference between a cancel signal and the phase opposite to that of noise.

A digital electroacoustic transducer apparatus according to the present invention includes: a signal processing circuit that generates a digital processing signal based on a digital signal from a sound source; a first drive unit that receives the digital processing signal; a sound pickup unit that picks up noise and generates a noise signal; a noise canceling circuit that generates a cancel signal based on the noise signal; and a second drive unit that receives the cancel signal.

The present invention can provide a digital electroacoustic transducer apparatus including an NC system with a reduced phase difference between a cancel signal and the phase opposite to that of noise.

### BRIEF DESCRIPTION THE DRAWINGS

FIG. 1 is a perspective view showing an embodiment (first embodiment) of a digital electroacoustic transducer apparatus according to the present invention;

FIG. 2 is a schematic view showing a configuration of a first sound output unit included in the digital electroacoustic transducer apparatus shown in FIG. 1;

FIG. 3 is a schematic view showing another embodiment (second embodiment) of the digital electroacoustic transducer apparatus according to the present invention;

FIG. 4 is a schematic view showing yet another embodiment (third embodiment) of the digital electroacoustic transducer apparatus according to the present invention;

FIG. 5 is a schematic view showing yet another embodiment (fourth embodiment) of the digital electroacoustic transducer apparatus according to the present invention;

FIG. 6 is a schematic view showing yet another embodiment (fifth embodiment) of the digital electroacoustic transducer apparatus according to the present invention; and

FIG. 7 is a schematic view showing yet another embodiment (sixth embodiment) of the digital electroacoustic transducer apparatus according to the present invention.

### DETAILED DESCRIPTION

Some embodiments of the digital electroacoustic transducer apparatus (hereinafter referred to as “the present apparatus”) according to the present invention will now be described with reference to the accompanying drawings.

The present apparatus is a digital electroacoustic transducer apparatus, such as a speaker, headphones, and earphones, that outputs sound waves based on audio signals (digital signals) from a sound source, such as a portable music sound reproducer. In the following description, the present apparatus will be described by taking headphones as an example.

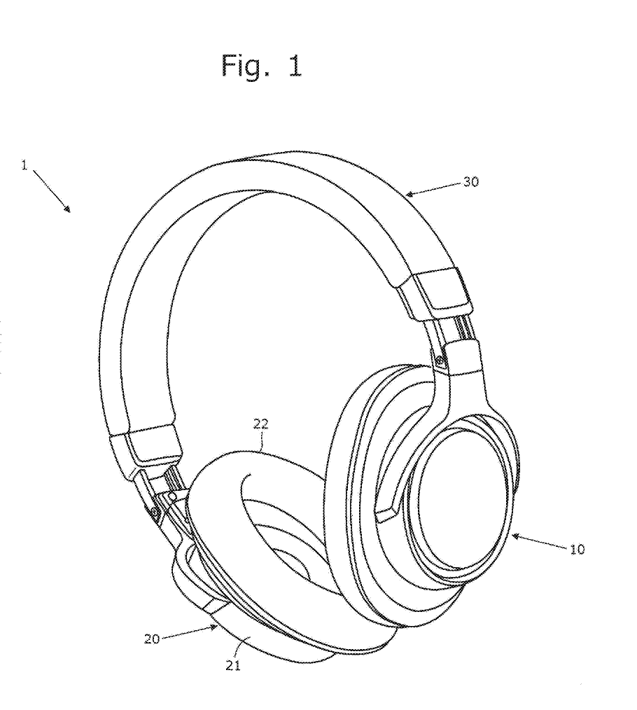

Referring to FIG. 1, this present apparatus 1 is worn on the head of a user of the present apparatus 1 and outputs sound waves based on audio signals (digital signals) from a sound source. The present apparatus 1 is wired headphones to which audio signals from the sound source are input via, for example, a universal serial bus (USB) cable (not shown in the drawing).

Note that the present apparatus may be wireless headphones that receive audio signals from a sound source, using wireless transmission such as Bluetooth (registered trademark), for example.

In the following description, the directions of the top and bottom, left and right, and front and rear of the present apparatus 1 are the same as the directions of the top and bottom, left and right, and front and rear of the user wearing the present apparatus 1.

The present apparatus 1 according to the first embodiment includes a first sound output unit 10, a second sound output unit 20, and a connecting member 30. The first sound output unit 10 will be described later.

The second sound output unit 20 is worn around the right ear of the user, and outputs sound waves based on audio signals from the sound source. The configuration of the second sound output unit 20 is common to the configuration of the first sound output unit 10 except that it does not include an input unit and a signal processing circuit, which will be described later. In particular, the second sound output unit 20 includes a housing 21, an earpad 22, a sound pickup unit (not shown in the drawing), a noise canceling circuit (not shown in the drawing), a first drive unit (not shown in the drawing), and a second drive unit (not shown in the drawing).

The connecting member 30 connects the first sound output unit 10 and the second sound output unit 20 to each other.

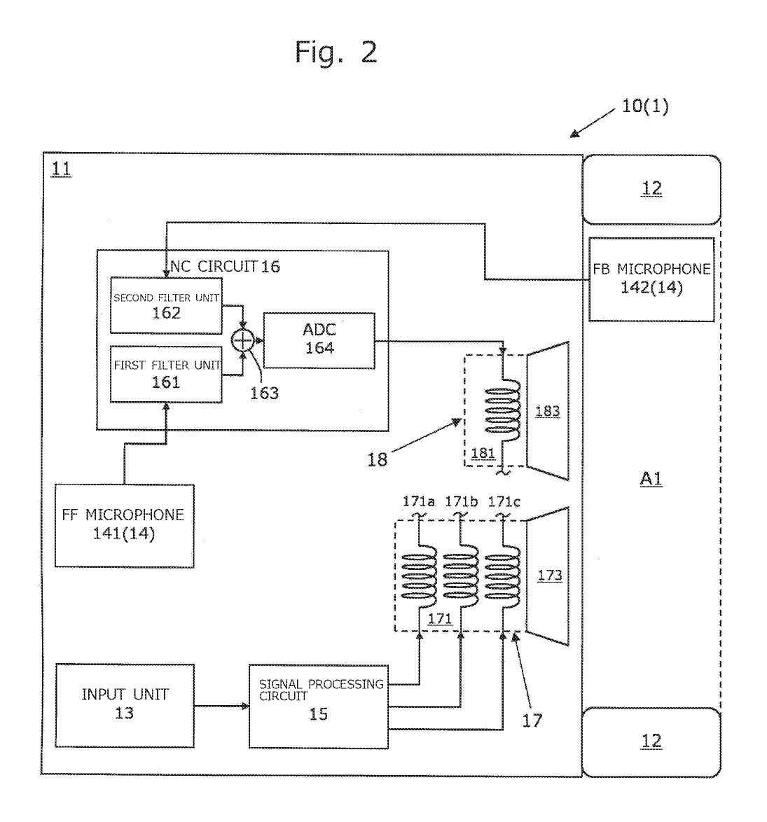

Referring to FIG. 2, the first sound output unit 10 is worn around the left ear of the user, and outputs sound waves based on audio signals from the sound source. The first sound output unit 10 includes a housing 11, an earpad 12, an input unit 13, a sound pickup unit 14, a signal processing circuit 15, a noise canceling (NC) circuit 16, a first drive unit 17, and a second drive unit 18.

The housing 11 contains the input unit 13, the signal processing circuit 15, the NC circuit 16, the first drive unit 17, and the second drive unit 18. The housing 11 includes a baffle plate (not shown in the drawing).

The earpad 12 is a cushioning material between the housing 11 and the user's head. When the present apparatus 1 is worn on the user's head, the earpad 12 forms a closed space (hereinafter referred to as a “front air chamber”) A1 between the housing 11 and the user's head. The earpad 12 is attached to the baffle plate (not shown in the drawing).

The input unit 13 is a terminal for digital signals such as a USB terminal, for example. Audio signals from the sound source are input to the input unit 13 via the USB cable. Audio signals input to the input unit 13 are digital signals.

The sound pickup unit 14 picks up noise outside the housing 11 and generates a noise signal. The sound pickup unit 14 includes a feedforward microphone (hereinafter referred to as an “FF microphone”) 141 and a feedback microphone (hereinafter referred to as an “FB microphone”) 142.

“Noise” is a sound that reaches the housing 11 or the front air chamber A1 from a sound source different from a sound source such as a portable music sound reproducer.

The FF microphone 141 picks up noise outside the housing 11 and generates a first noise signal. The FF microphone 141 is a first microphone of the present invention. The FF microphone 141 is disposed, for example, in a position in the housing 11 where it can pick up noise outside the housing 11.

The FB microphone 142 picks up, from noise outside the housing 11, noise entering the front air chamber A1 via the earpad 12 and sound waves (sound) output from the first drive unit 17 to the front air chamber A1, and generates a second noise signal.

In other words, the second noise signal includes a noise component and a sound component. The FB microphone 142 is a second microphone of the present invention. The FB microphone 142 is, for example, attached to the baffle plate (not shown in the drawing) and disposed in the front air chamber A1.

Note that the FB microphone 142 of the present invention may be disposed in the housing 11 as long as it can pick up noise entering the front air chamber A1.

The signal processing circuit 15 processes an audio signal from the sound source in the state where it is a digital signal, and generates a digital processing signal for oscillating a first diaphragm 173, which will be described later, according to the audio signal. The signal processing circuit 15 is a DSP, for example.

A “digital processing signal” is, for example, a digital signal obtained by applying a pulse-density modulation (PDM) process to an audio signal. The digital processing signal is transmitted to the first drive unit 17 and the first drive unit (not shown in the drawing) of the second sound output unit 20 via a cable (not shown in the drawing). The digital processing signal is applied to a sound voice coil 171 described later.

In the first embodiment, the NC circuit 16 generates a cancel signal based on a noise signal (a first noise signal from the FF microphone 141 and a second noise signal from the FB microphone 142) from the sound pickup unit 14. The NC circuit 16 includes a first filter unit 161, a second filter unit 162, an adder unit 163, and an analog-to-digital converter (hereinafter referred to as an “ADC”) 164.

The “cancel signal” is a digital signal for vibrating a second diaphragm 183, which will be described later, so as to cancel out (cancel) noise entering the front air chamber A1. The cancel signal is applied to a noise voice coil 181, which will be described later, in the second drive unit 18.

The first filter unit 161 analyzes the first noise signal from the FF microphone 141 and predicts a change in noise occurring until the noise reaches the front air chamber A1. The first filter unit 161 inverts the phase of the first noise signal according to the result of the prediction, thereby generating a first signal for noise cancellation.

The second filter unit 162 extracts a noise component from the second noise signal from the FB microphone 142, and inverts the phase of the noise component (makes the phase opposite), thereby generating a second signal for noise cancellation.

The adder unit 163 may be a known adder that adds the first signal and the second signal together by analog processing.

The first filter unit 161, the second filter unit 162, and the adder unit 163 are filter units of the present invention that perform analog processing on noise signals.

The ADC 164 converts the signal calculated by addition through the adder unit 163 into a digital signal, thereby generating a cancel signal.

The first drive unit 17 generates sound waves based on the digital processing signal from the signal processing circuit 15, and outputs them to the front air chamber A1. The first drive unit 17 is attached to a baffle plate (not shown in the drawing) and disposed in the housing 11. The first drive unit 17 includes the sound voice coil 171, a first voice coil bobbin (not shown in the drawing), the first diaphragm 173, and a first magnetic circuit (not shown in the drawing).

The sound voice coil 171 is driven by a digital processing signal from the signal processing circuit 15 and vibrates the first diaphragm 173 in accordance with the digital processing signal. In this embodiment, the sound voice coil 171 includes a plurality of (three) individual sound voice coils 171a, 171b, and 171c.

A digital processing signal applied to the sound voice coil 171 includes a plurality of (three in this embodiment) individual digital processing signals corresponding to the plurality of individual sound voice coils 171a to 171c. The individual digital processing signals are applied to the respective individual sound voice coils 171a to 171c.

The individual sound voice coils 171a to 171c are driven by the individual digital processing signals, which are different from each other, and vibrate the first diaphragm 173 in accordance with the individual digital processing signals. The individual sound voice coils 171a to 171c are attached to the first diaphragm 173 and are wound around the first voice coil bobbin disposed in the magnetic gap of the first magnetic circuit, which will be described later (both are not shown in the drawing).

At this time, the individual sound voice coils 171a to 171c are attached to the first diaphragm 173 in the state where they are twisted together. Therefore, even if a digital signal containing a harmonic component is applied to the sound voice coil 171, the skin effect hardly occurs and the reproducibility of high frequency does not deteriorate for audio signals from the sound source.

Note that the individual sound voice coils may be bundled, may be stacked in multiple layers concentrically, or may be arranged side by side.

The first diaphragm 173 is driven by the sound voice coil 171 and thus vibrates, and generates and outputs sound waves. The first diaphragm 173 can vibrate with respect to the first magnetic circuit.

The first magnetic circuit generates a magnetic field. The first magnetic circuit includes a magnetic gap (not shown in the drawing) that the magnetic flux passes at a uniform density. The sound voice coil 171 is disposed in the magnetic gap so as to cross the magnetic flux.

The sound voice coil 171 vibrates with respect to the first magnetic circuit through the electromagnetic force generated by the digital processing signal applied to the sound voice coil 171. Consequently, the first diaphragm 173 generates sound waves corresponding to audio signals from the sound source and outputs them to the front air chamber A1.

The second drive unit 18 generates sound waves based on the cancel signal and outputs them to the front air chamber A1. The second drive unit 18 is attached to a baffle plate (not shown in the drawing) and disposed in the housing 11. The second drive unit 18 includes the noise voice coil 181, a second voice coil bobbin (not shown in the drawing), the second diaphragm 183, and a second magnetic circuit (not shown in the drawing).

Note that the second drive unit 18 may be attached to the baffle plate to which the first drive unit 17 is attached, or may be attached to a baffle plate different from the baffle plate to which the first drive unit 17 is attached. In other words, the housing 11 may include the same number of baffle plates as that of drive units (two in this embodiment).

The noise voice coil 181 is driven by a cancel signal from the NC circuit 16 and vibrates the second diaphragm 183 in accordance with the cancel signal. The noise voice coil 181 is attached to the second diaphragm 183 and is wound around the second voice coil bobbin disposed in the magnetic gap of the second magnetic circuit, which will be described later (both are not shown in the drawing).

The second diaphragm 183 is driven by the noise voice coil 181 and thus vibrates, and generates and outputs sound waves. The second diaphragm 183 can vibrate with respect to the second magnetic circuit.

The second magnetic circuit generates a magnetic field. The second magnetic circuit includes a magnetic gap (not shown in the drawing) that the magnetic flux passes at a uniform density. The noise voice coil 181 is disposed in the magnetic gap so as to cross the magnetic flux.

The noise voice coil 181 vibrates with respect to the second magnetic circuit through the electromagnetic force generated by the cancel signal applied to the noise voice coil 181. Consequently, the second diaphragm 183 generates sound waves corresponding to the cancel signal and outputs them to the front air chamber A1.

Next, the operation of the present apparatus 1 according to the first embodiment will be described with reference to FIG. 2, taking the operation of the first sound output unit 10 as an example.

Audio signals from a sound source (not shown in the drawing) are input to the signal processing circuit 15 via the input unit 13. The signal processing circuit 15 generates a plurality of individual digital processing signals based on the audio signals that are digital signals. The individual digital processing signals are amplified by a digital amplifier (not shown in the drawing) and are applied to the respective individual sound voice coils 171a to 171c of the first drive unit 17.

Noise outside the housing 11 is picked up by the FF microphone 141. The FF microphone 141 generates a first noise signal based on the picked up noise. The first noise signal is input to the NC circuit 16.

On the other hand, out of the noise outside the housing 11, the noise entering the front air chamber A1 through the earpad 12 is picked up by the FB microphone 142. At this time, the FB microphone 142 also picks up the sound output from the first drive unit 17 to the front air chamber A1. The FB microphone 142 generates a second noise signal based on the picked up noise and sound. The second noise signal is input to the NC circuit 16.

The first filter unit 161 generates a first signal based on the first noise signal from the FF microphone 141. The first signal is a signal opposite in phase to the first noise signal.

The second filter unit 162 generates a second signal based on the second noise signal from the FB microphone 142. The second signal is a signal opposite in phase to a signal obtained by extracting a noise component from (removing (suppressing) the sound component from (in)) the second noise signal.

The NC circuit 16 adds the first signal and the second signal together in the adder unit 163 and converts the sum to a digital signal in the ADC 164, thereby generating a cancel signal. The cancel signal is amplified by a digital amplifier (not shown in the drawing) and is applied to the noise voice coil 181 of the second drive unit 18.

In the NC circuit 16, the generation of a cancel signal (the output of the adder unit 163) is analog processing that does not involve digital processing by a DSP or the like. Accordingly, the present apparatus 1 requires less time to generate a cancel signal than a conventional electro-acoustic transducer (hereinafter referred to as a “conventional apparatus”) that generates a cancel signal by digital processing through a DSP. In other words, the cancel signal generated by the present apparatus 1 is less delayed than the cancel signal generated by the conventional apparatus.

The sound voice coil 171 vibrates with the electromagnetic force generated through a relationship between the applied digital processing signal and the magnetic flux in the magnetic gap. Similarly, the noise voice coil 181 vibrates with the electromagnetic force generated through a relationship between the applied cancel signal and the magnetic flux in the magnetic gap.

To be specific, the first diaphragm 173 vibrates with vibration of the sound voice coil 171, and the second diaphragm 183 vibrates with vibration of the noise voice coil 181. Consequently, the sound waves from the first diaphragm 173 are acoustically synthesized with the sound waves from the second diaphragm 183 within the front air chamber A1.

As described above, the first drive unit 17 is a drive unit solely for sound that outputs sound based on the digital processing signal, and the second drive unit 18 is a drive unit dedicated to noise cancellation that outputs a cancel sound (a sound of canceling out (suppressing) the noise entering the front air chamber A1) based on the cancel signal.

In other words, the present apparatus 1 does not require an adder circuit for electrically adding the digital processing signal and the cancel signal together by digital processing. Hence, the cancel signal generated by the present apparatus 1 is not affected by the phase characteristics of the adder circuit. Consequently, the phase of the cancel signal generated by the present apparatus 1 does not change between the NC circuit 16 and the noise voice coil 181.

Sound waves output from the first diaphragm 173 correspond to a sound based on audio signals from the sound source. On the other hand, sound waves output from the second diaphragm 183 correspond to a cancel sound. As described above, the cancel signal generated by the present apparatus 1 is less delayed from noise and does not change in phase.

Accordingly, the phase of the cancel sound output from the present apparatus 1 (the cancel signal generated by the present apparatus 1) has a smaller phase difference from the phase opposite to that of noise than the cancel sound output from the conventional apparatus (the cancel signal generated by the conventional apparatus). Consequently, the noise cancellation effect produced when the cancel sound output from the present apparatus 1 is acoustically coupled to the noise entering the front air chamber A1 is higher than in the conventional apparatus.

According to the embodiment described above (first embodiment), the present apparatus 1 includes the first drive unit 17 solely for sound that outputs sound based on the digital processing signal, and the second drive unit 18 dedicated to noise cancellation that outputs a cancel sound based on the cancel signal.

Accordingly, the cancel signal is generated by the NC circuit 16 and is applied to the noise voice coil 181 without going through the signal processing circuit 15. Hence, the present apparatus 1 requires less time to generate the cancel signal than the conventional apparatus. In other words, the cancel signal generated by the present apparatus 1 is less delayed than the cancel signal generated by the conventional apparatus.

In addition, the digital processing signal generated by processing the audio signal is applied to the sound voice coil 171, and the cancel signal generated by processing the noise signal is applied to the noise voice coil 181. In other words, the cancel signal is applied to the noise voice coil 181 without being electrically added to the digital processing signal by digital processing.

For this reason, the present apparatus 1 does not require an adder circuit for electrically adding the digital processing signal and the cancel signal together by digital processing. Hence, the cancel signal generated by the present apparatus 1 is not affected by the phase characteristics of the adder circuit. In other words, the phase of the cancel signal generated by the present apparatus 1 does not change.

Thus, the present apparatus 1 is less prone to a delay of the cancel signal or a change in the phase of the cancel signal than the conventional apparatus. In other words, the present apparatus 1 contributes to a reduction in a difference between the phase of the cancel signal and the phase opposite to that of noise, compared with the conventional apparatus.

Further, according to the first embodiment described above, the NC circuit 16 generates the first signal and the second signal by analog processing and adds them together. The NC circuit 16 generates a cancel signal by converting a signal, which is generated by adding the first signal and the second signal together, to a digital signal. Accordingly, the present apparatus 1 requires less time to generate the cancel signal than the conventional apparatus. In other words, the cancel signal generated by the present apparatus 1 is less delayed than the cancel signal generated by the conventional apparatus.

In addition, the present apparatus 1 according to the first embodiment described above has a hybrid-type noise canceling function which is a combination of a feedforward noise canceling function and a feedback noise canceling function. Alternatively, the present apparatus may have only the feedforward noise canceling function, or may have only the feedback noise canceling function. In other words, the present apparatus may include only the FF microphone, or may include only the FB microphone.

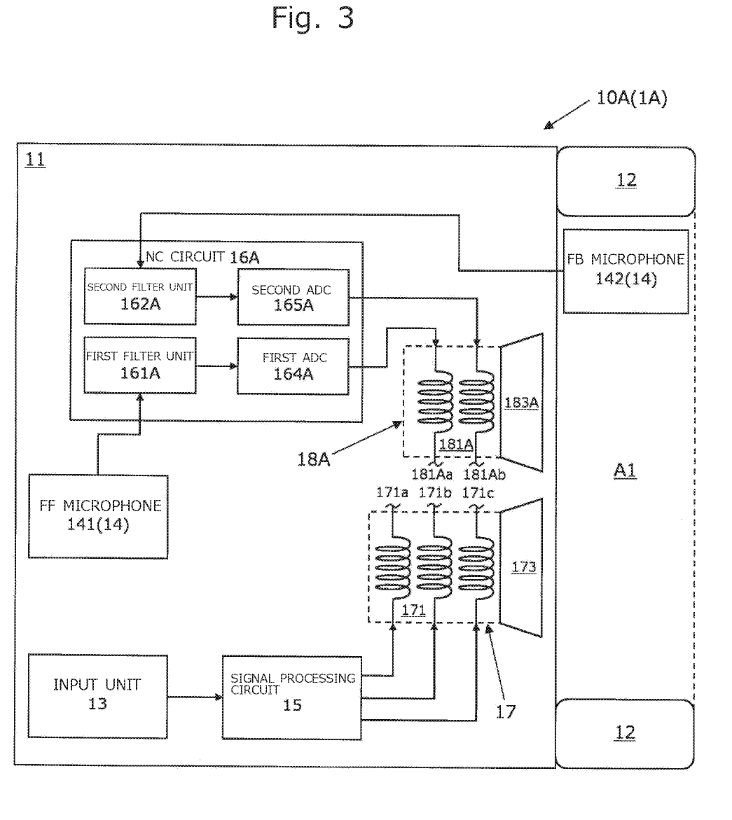

Next, referring to FIG. 3, another embodiment of the present apparatus (second embodiment) will be described focusing on the points different from those of the first embodiment described above. The digital electro-acoustic transducer 1A according to the second embodiment differs from that according to the first embodiment in the configuration of the NC circuit and the configuration of the second drive unit.

FIG. 3 is a schematic view showing only the configuration of a first sound output unit 10A included in the present apparatus 1A. In the drawing, a member denoted by the same reference numeral as in another drawing has the same function as the corresponding member in the other drawing.

The present apparatus 1A is composed of the first sound output unit 10A. The first sound output unit 10A includes a housing 11, an earpad 12, an input unit 13, a sound pickup unit 14, a signal processing circuit 15, an NC circuit 16A, a first drive unit 17, and a second drive unit 18A.

The NC circuit 16A generates a first cancel signal based on the first noise signal generated by the FF microphone 141 and also generates a second cancel signal based on the second noise signal generated by the FB microphone 142. The NC circuit 16A includes a first filter unit 161A, a second filter unit 162A, a first ADC 164A, and a second ADC 165A.

The first filter unit 161A analyzes the first noise signal from the FF microphone 141 and predicts a change in noise occurring until the noise reaches the front air chamber A1. The first filter unit 161A inverts the first noise signal according to the result of the prediction, thereby generating a first signal for noise cancellation. The first signal is input to the first ADC 164A.

The second filter unit 162A extracts a noise component from the second noise signal transmitted from the FB microphone 142 and inverts its phase (makes it opposite in phase), thereby generating a second signal for noise cancellation. The second signal is input to the second ADC 165A.

The first ADC 164A generates a first cancel signal by converting the first signal, which is generated by the first filter unit 161A, to a digital signal. The first cancel signal is applied to a first noise voice coil 181Aa, which will be described later, in the second drive unit 18A.

The second ADC 165A generates a second cancel signal by converting the second signal, which is generated by the second filter unit 162A, to a digital signal. The second cancel signal is applied to a second noise voice coil 181Ab, which will be described later, in the second drive unit 18A.

The first filter unit 161A and the first ADC 164A constitute a first circuit of the present invention. The second filter unit 162A and the second ADC 165A constitute a second circuit of the present invention. The first circuit and the second circuit serve as a filter unit of the present invention for analog processing of the noise signal.

The second drive unit 18A generates sound waves based on the cancel signal (the first cancel signal and the second cancel signal) and outputs the sound waves to the front air chamber A1. The second drive unit 18A is attached to a baffle plate (not shown in the drawing) and is disposed in the housing 11. The second drive unit 18A includes a noise voice coil 181A, a second voice coil bobbin (not shown in the drawing), a second diaphragm 183A, and a second magnetic circuit (not shown in the drawing).

The noise voice coil 181A is driven by the cancel signal from the NC circuit 16A and vibrates the second diaphragm 183A in accordance with the cancel signal. The noise voice coil 181A includes the first noise voice coil 181Aa and the second noise voice coil 181Ab.

The first noise voice coil 181Aa is driven by the first cancel signal and vibrates the second diaphragm 183A in accordance with the first cancel signal. The second noise voice coil 181Ab is driven by the second cancel signal and vibrates the second diaphragm 183A in accordance with the second cancel signal.

The first noise voice coil 181Aa and the second noise voice coil 181Ab are attached to the second diaphragm 183A and are wound around the second voice coil bobbin (not shown in the drawing) disposed in the magnetic gap (not shown in the drawing) of the second magnetic circuit.

In other words, the first noise voice coil 181Aa and the second noise voice coil 181Ab are attached to a common diaphragm, i.e., the second diaphragm 183A. In this case, the first noise voice coil 181Aa is attached to the second diaphragm 183A in the state where it is twisted together with the second noise voice coil 181Ab.

The second diaphragm 183A is driven by the noise voice coil 181A and thus vibrates, and generates and outputs sound waves. The second diaphragm 183A can vibrate with respect to the second magnetic circuit.

The second magnetic circuit has the same configuration as the second magnetic circuit according to the first embodiment. The noise voice coil 181A is disposed in the magnetic gap so as to cross the magnetic flux. The noise voice coil 181A vibrates with respect to the second magnetic circuit through the electromagnetic force generated by the cancel signal applied to the noise voice coil 181A. Consequently, the second diaphragm 183A generates sound waves corresponding to the cancel signal and outputs them to the front air chamber A1.

Next, the operation of the present apparatus 1A according to the second embodiment will be described with reference to FIG. 3 taking the operation of the first sound output unit 10A as an example.

First, the operations of the input unit 13, the signal processing circuit 15, and the first drive unit 17 are the same as the operations of the input unit 13, the signal processing circuit 15, and the first drive unit 17 according to the first embodiment, respectively.

The first filter unit 161A generates a first signal based on the first noise signal from the FF microphone 141. The first signal is a signal opposite in phase to the first noise signal. The first ADC 164A generates a first cancel signal by converting the first signal to a digital signal.

In other words, the first circuit generates a first cancel signal based on the first noise signal. The first cancel signal is amplified by a digital amplifier (not shown in the drawing) and is applied to the first noise voice coil 181Aa.

The second filter unit 162A generates a second signal based on the second noise signal from the FB microphone 142. The second signal is a signal opposite in phase to a signal obtained by extracting a noise component from (removing (suppressing) the sound component from (in)) the second noise signal.

The second ADC 165A generates a second cancel signal by converting the second signal to a digital signal. In other words, the second circuit generates a second cancel signal based on the second noise signal. The second cancel signal is amplified by a digital amplifier (not shown in the drawing) and is applied to the second noise voice coil 181Ab.

The generation of the cancel signals (the first cancel signal and the second cancel signals) in the NC circuit 16A is analog processing that does not involve digital processing by a DSP or the like. Hence, the present apparatus 1A requires less time to generate the cancel signals than the conventional apparatus. In other words, the cancel signals generated by the present apparatus 1A are less delayed than the cancel signals generated by the conventional apparatus.

The sound voice coil 171 vibrates with the electromagnetic force generated through a relationship between the applied digital processing signal and the magnetic flux in the magnetic gap. The first diaphragm 173 vibrates with the vibration of the sound voice coil 171.

The first noise voice coil 181Aa vibrates with the electromagnetic force generated through a relationship between the applied first cancel signal and the magnetic flux in the magnetic gap. Similarly, the second noise voice coil 181Ab vibrates with the electromagnetic force generated through a relationship between the applied second cancel signal and the magnetic flux in the magnetic gap.

The second diaphragm 183A vibrates with the vibration of the first noise voice coil 181Aa and the vibration of the second noise voice coil 181Ab. In particular, the vibration of the second diaphragm 183A is a combination of the vibration of the first noise voice coil 181Aa and the vibration of the second noise voice coil 182Ab. In other words, the first cancel signal and the second cancel signal are mechanically synthesized in the second diaphragm 183A.

As described above, the first diaphragm 173 vibrates with the vibration of the sound voice coil 171, and the second diaphragm 183A vibrates with the vibration of the noise voice coil 181A (the first noise voice coil 181Aa and the second noise voice coil 181Ab). Consequently, the sound waves output from the first diaphragm 173 are acoustically synthesized with the sound waves output from the second diaphragm 183A within the front air chamber A1.

As described above, the first drive unit 17 is a drive unit solely for sound that outputs sound based on the digital processing signal, and the second drive unit 18A is a drive unit dedicated to noise cancellation that outputs a cancel sound based on the cancel signal.

In other words, the present apparatus 1A does not require an adder circuit for adding the digital processing signal and the cancel signal together by digital processing. Hence, the cancel signal generated by the present apparatus 1A is not affected by the phase characteristics of the adder circuit. Consequently, the phase of the cancel signal generated by the present apparatus 1A does not change between the NC circuit 16A and the noise voice coil 181A.

Here, the present apparatus 1 according to the first embodiment described above adds the first signal and the second signal together through the NC circuit 16. For this reason, the first signal in the present apparatus 1 can be affected by the sound components that may be included in the second signal (the sound components remaining without being removed by the NC circuit 16), before being applied to the noise voice coil 181. Besides, the second signal in the present apparatus 1 of the first embodiment may also be electrically affected by the first signal.

In contrast, the first cancel signal in the present apparatus 1A according to the second embodiment is applied to the first noise voice coil 181Aa without being added to the second cancel signal. For this reason, the first noise voice coil 181Aa is not affected by the sound components that may be included in the second cancel signal (the sound components remaining without being removed by the second filter unit 162A).

Further, the second cancel signal is applied to the second noise voice coil 181Ab without being added to the first cancel signal. For this reason, the second noise voice coil 181Ab is not affected by the first cancel signal.

Consequently, the second drive unit 18A of the present apparatus 1A vibrates more faithfully to the first cancel signal (the first signal) and the second cancel signal (the second signal) than the second drive unit 18 of the first embodiment that operates according to the cancel signal generated by adding the first signal and the second signal together. In other words, the present apparatus 1A achieves a noise cancellation effect faithful to the cancel signals (the first cancel signal and the second cancel signal) compared with the present apparatus 1 of the first embodiment.

According to the second embodiment described above, the present apparatus 1A includes the first drive unit 17 solely for sound that outputs sound based on the digital processing signal, and the second drive unit 18A dedicated to noise cancellation that outputs a cancel sound based on the cancel signals.

Thus, like the present apparatus 1 in the first embodiment, the present apparatus 1A is less prone to a delay of the cancel signal or a change in the phase of the cancel signal than the conventional apparatus. In other words, the present apparatus 1A contributes to a reduction in a difference between the phase of a cancel signal and the phase opposite to that of noise, compared with the conventional apparatus.

Further, the present apparatus 1A includes a first noise voice coil 181Aa dedicated to the first cancel signal, and a second noise voice coil 181Ab dedicated to the second cancel signal. Accordingly, the first noise voice coil 181Aa is not affected by the sound components that may be included in the second cancel signal, and the second noise voice coil 181Ab is not affected by the first cancel signal. Consequently, the present apparatus 1A achieves a noise cancellation effect faithful to the cancel signals (the first cancel signal and the second cancel signal) compared with the present apparatus 1 of the first embodiment.

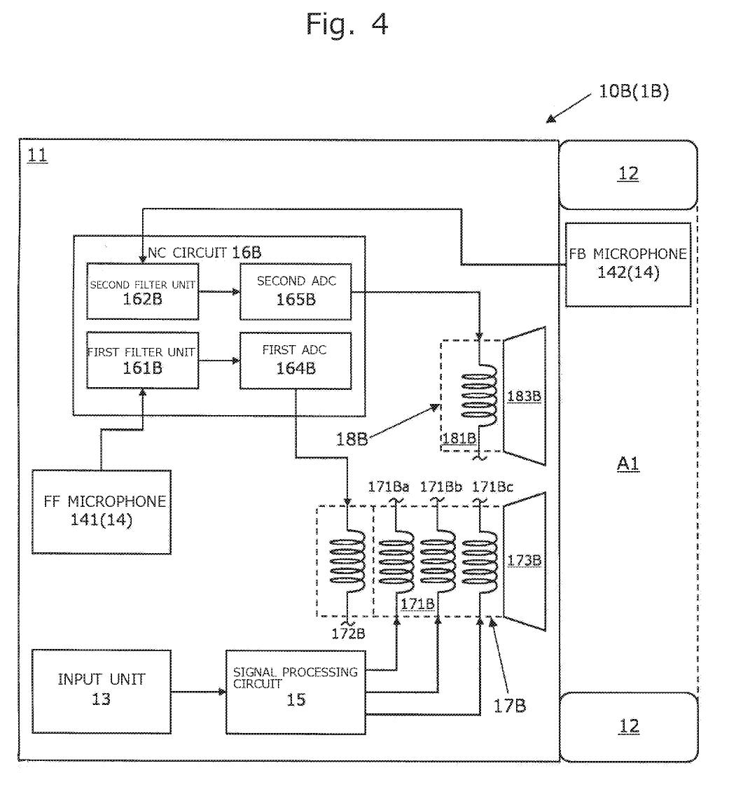

Next, referring to FIG. 4, yet another embodiment of the present apparatus (third embodiment) will be described focusing on the points different from those of the first and second embodiments described above. A digital electro-acoustic transducer 1B according to the third embodiment differs from that of the first embodiment in the configuration of the NC circuit, and differs from the first and second embodiments in the operation of the NC circuit, the configuration of the first drive unit, and the operation of the second drive unit.

FIG. 4 is a schematic view showing only the configuration of a first sound output unit 10B included in the present apparatus 1B according to the third embodiment. In the drawing, a member denoted by the same reference numeral as in another drawing has the same function as the corresponding member in the other drawing.

The present apparatus 1B includes the first sound output unit 10B. The first sound output unit 10B includes a housing 11, an earpad 12, an input unit 13, a sound pickup unit 14, a signal processing circuit 15, an NC circuit 16B, a first drive unit 17B, and a second drive unit 18B.

The NC circuit 16B generates a first cancel signal based on the first noise signal generated by the FF microphone 141 and also generates a second cancel signal based on the second noise signal generated by the FB microphone 142. The NC circuit 16B includes a first filter unit 161B, a second filter unit 162B, a first ADC 164B, and a second ADC 165B.

The first filter unit 161B and the first filter unit 161A of the second embodiment have a common configuration. The second filter unit 162B and the second filter unit 162A of the second embodiment have a common configuration.

The first ADC 164B generates a first cancel signal by converting the first signal, which is generated by the first filter unit 161B, to a digital signal. The first cancel signal is applied to a first noise voice coil 172B, which will be described later, in the first drive unit 17B.

The second ADC 165B generates a second cancel signal by converting the second signal, which is generated by the second filter unit 162B, to a digital signal. The second cancel signal is applied to a second noise voice coil 181B, which will be described later, in the second drive unit 18B.

The first filter unit 161B and the first ADC 164B constitute a first circuit of the present invention. The second filter unit 162B and the second ADC 165B constitute a second circuit of the present invention. The first circuit and the second circuit serve as a filter unit of the present invention for analog processing of the noise signal.

The first drive unit 17B generates sound waves based on the digital processing signal and the cancel signal (the first cancel signal) and outputs them to the front air chamber A1. The first drive unit 17B is attached to a baffle plate (not shown in the drawing) and is disposed in the housing 11.

The first drive unit 17B includes a sound voice coil 171B, the first noise voice coil 172B, a first voice coil bobbin (not shown in the drawing), a first diaphragm 173B, and a first magnetic circuit (not shown in the drawing).

The sound voice coil 171B and the sound voice coil 171 of the first embodiment have a common configuration. In other words, the sound voice coil 171 includes a plurality of (three) individual sound voice coils 171Ba, 171Bb, and 171Bc.

The first noise voice coil 172B is driven by the first cancel signal from the NC circuit 16B and vibrates the first diaphragm 173B in accordance with the first cancel signal. The sound voice coil 171B and the first noise voice coil 172B are attached to the first diaphragm 173 and are wound around the first voice coil bobbin disposed in the magnetic gap of the first magnetic circuit.

In other words, the sound voice coil 171B and the first noise voice coil 172B are attached to a common diaphragm, i.e., the first diaphragm 173B. In this case, the first noise voice coil 172B is attached to the first diaphragm 173B in the state where it is twisted together with the sound voice coil 171B.

The first diaphragm 173B vibrates in response to the vibration of the sound voice coil 171B and the vibration of the first noise voice coil 172B, and generates and outputs sound waves. The first diaphragm 173B can vibrate with respect to the first magnetic circuit.

The second drive unit 18B generates sound waves based on the cancel signal (the second cancel signal) and outputs them to the front air chamber A1. The second drive unit 18B is attached to a baffle plate (not shown in the drawing) and is disposed in the housing 11. The second drive unit 18B includes the second noise voice coil 181B, a second voice coil bobbin (not shown in the drawing), a second diaphragm 183B, and a second magnetic circuit (not shown in the drawing).

The second noise voice coil 181B is driven by the second cancel signal from the NC circuit 16B and vibrates the second diaphragm 183B in accordance with the second cancel signal. The second noise voice coil 181B is attached to the second diaphragm 183B and is wound around the second voice coil bobbin disposed in the magnetic gap (not shown in the drawing) of the second magnetic circuit.

The second diaphragm 183B vibrates in response to the vibration of the second noise voice coil 181B and generates and outputs sound waves. The second diaphragm 183B can vibrate with respect to the second magnetic circuit.

The second magnetic circuit has the same configuration as the second magnetic circuit according to the first embodiment. The second noise voice coil 181B is disposed in the magnetic gap so as to cross the magnetic flux. The second noise voice coil 181B vibrates with respect to the second magnetic circuit through the electromagnetic force generated by the second cancel signal applied to the second noise voice coil 181B. Consequently, the second diaphragm 183B generates sound waves corresponding to the second cancel signal and outputs them to the front air chamber A1.

Next, the operation of the present apparatus 1B according to the third embodiment will be described with reference to FIG. 4 taking the operation of the first sound output unit 10B as an example.

The operations of the input unit 13 and the signal processing circuit 15 are the same as the operations of the input unit 13 and the signal processing circuit 15 according to the first embodiment, respectively.

The first filter unit 161B generates a first signal based on the first noise signal from the FF microphone 141. The first ADC 164B generates a first cancel signal by converting the first signal to a digital signal.

In other words, the first circuit generates a first cancel signal based on the first noise signal. The first cancel signal is amplified by a digital amplifier (not shown in the drawing) and is applied to the first noise voice coil 172B of the first drive unit 17B.

The second filter unit 162B generates a second signal based on the second noise signal. The second ADC 165B generates a second cancel signal by converting the second signal to a digital signal.

In other words, the second circuit generates a second cancel signal based on the second noise signal. The second cancel signal is amplified by a digital amplifier (not shown in the drawing) and is applied to the second noise voice coil 181B of the second drive unit 18B.

The generation of the cancel signals (the first cancel signal and the second cancel signals) in the NC circuit 16B is analog processing that does not involve digital processing by a DSP or the like. Hence, the present apparatus 1B requires less time to generate the cancel signal than the conventional apparatus. In other words, the cancel signal generated by the present apparatus 1B is less delayed than the cancel signal generated by the conventional apparatus.

The sound voice coil 171B vibrates with the electromagnetic force generated through a relationship between the applied digital processing signal and the magnetic flux in the magnetic gap. Similarly, the first noise voice coil 172B vibrates with the electromagnetic force generated through a relationship between the applied first cancel signal and the magnetic flux in the magnetic gap.

The first diaphragm 173B vibrates with the vibration of the sound voice coil 171B and the vibration of the first noise voice coil 172B. In other words, the vibration of the first diaphragm 173B is a combination of the vibration of the sound voice coil 171B and the vibration of the first noise voice coil 172B. In other words, the digital processing signal and the first cancel signal are mechanically synthesized in the first diaphragm 173B.

The second noise voice coil 181B vibrates with the electromagnetic force generated through a relationship between the applied second cancel signal and the magnetic flux in the magnetic gap. The second diaphragm 183B vibrates with the vibration of the second noise voice coil 181B.

As described above, the first diaphragm 173B vibrates with the vibration of the sound voice coil 171B and the vibration of the first noise voice coil 172B, and the second diaphragm 183B vibrates with the vibration of the second noise voice coil 181B. Consequently, the sound waves output from the first diaphragm 173B are acoustically synthesized with the sound waves output from the second diaphragm 183B within the front air chamber A1.

Thus, in the present apparatus 1B, the digital processing signal and the first cancel signal are synthesized directly in the first diaphragm 173B without passing through the adder circuit. In addition, the second drive unit 18B is a drive unit that is dedicated to noise cancellation and outputs part of the cancel sound based on the second cancel signal.

In other words, the present apparatus 1B does not require an adder circuit for adding the digital processing signal and the cancel signals (the first cancel signal and the second cancel signal) together by digital processing. Hence, the cancel signal generated by the present apparatus 1B is not affected by the phase characteristics of the adder circuit. Consequently, the phase of the first cancel signal generated by the present apparatus 1B does not change between the NC circuit 16B and the first noise voice coil 172B. The phase of the second cancel signal generated by the present apparatus 1B does not change between the NC circuit 16B and the second noise voice coil 181B.

In addition, the first cancel signal in the present apparatus 1B is applied to the first noise voice coil 172B without being added to the second cancel signal. Therefore, the first noise voice coil 172B is not affected by the sound components that may be included in the second cancel signal (the sound components remaining without being removed by the second filter unit 162B).

In addition, the second cancel signal is applied to the second noise voice coil 181B without being added to the first cancel signal. For this reason, the second noise voice coil 181B is not affected by the first cancel signal. Consequently, the first drive unit 17B of the present apparatus 1B vibrates more faithfully to the first cancel signal than the second drive unit 18 of the first embodiment.

The second drive unit 18B of the present apparatus 1B vibrates more faithfully to the second cancel signal (the second signal) than the second drive unit 18 of the first embodiment. In other words, the present apparatus 1B achieves a noise cancellation effect faithful to the cancel signals (the first cancel signal and the second cancel signal) compared with the present apparatus 1 of the first embodiment.

According to the present apparatus 1B according to the third embodiment described above, the first cancel signal is applied to the first drive unit 17B, and the second cancel signal is applied to the second drive unit 18B. Thus, like the present apparatus 1 in the first embodiment, the present apparatus 1B is less prone to a delay of the cancel signal or a change in the phase of the cancel signal than the conventional apparatus. In other words, the present apparatus 1B contributes to a reduction in a difference between the phase of the cancel signal and the phase opposite to that of noise, compared with the conventional apparatus.

Further, the present apparatus 1B includes the first noise voice coil 172B dedicated to the first cancel signal, and the second noise voice coil 181B dedicated to the second cancel signal. Consequently, like the present apparatus 1A of the second embodiment, the present apparatus 1B achieves a noise cancellation effect faithful to the cancel signals (the first cancel signal and the second cancel signal) compared with the present apparatus 1 of the first embodiment.

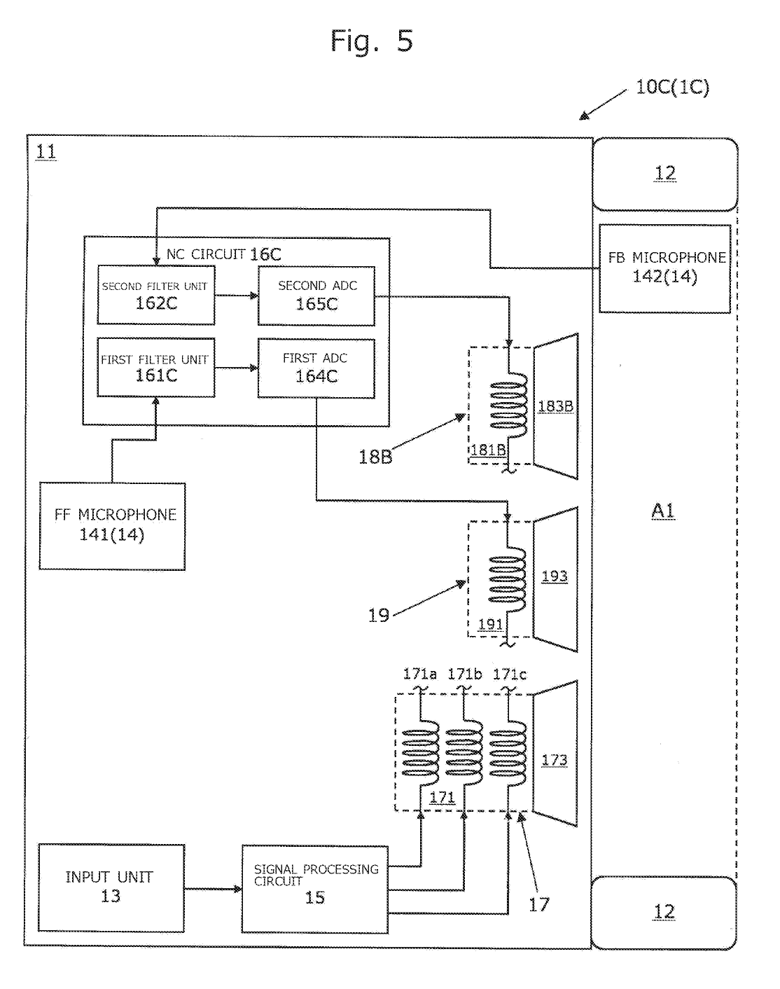

Next, referring to FIG. 5, a fourth embodiment of the present apparatus will be described focusing on the points different from those of the embodiments described above (the first, second, and third embodiments). A digital electro-acoustic transducer 1C according to the fourth embodiment differs from that according to the third embodiment in the operation of the NC circuit and in that it includes a third drive unit.

FIG. 5 is a schematic view showing only the configuration of a first sound output unit 10C included in the present apparatus 1C according to the fourth embodiment. In the drawing, a member denoted by the same reference numeral as in another drawing has the same function as the corresponding member in the other drawing.

The present apparatus 1C includes the first sound output unit 10C. The first sound output unit 10C includes a housing 11, an earpad 12, an input unit 13, a sound pickup unit 14, a signal processing circuit 15, an NC circuit 16C, a first drive unit 17, a second drive unit 18B, and a third drive unit 19.

The NC circuit 16C generates a first cancel signal based on the first noise signal generated by the FF microphone 141 and also generates a second cancel signal based on the second noise signal generated by the FB microphone 142. The NC circuit 16C includes a first filter unit 161C, a second filter unit 162C, a first ADC 164C, and a second ADC 165C.

The first filter unit 161C and the first filter unit 161A of the second embodiment have a common configuration. In addition, the second filter unit 162C and the second filter unit 162A of the second embodiment have a common configuration.

The first ADC 164C generates a first cancel signal by converting the first signal, which is generated by the first filter unit 161C, to a digital signal. The first cancel signal is applied to a first noise voice coil 191, which will be described later, in the third drive unit 19.

The second ADC 165C generates a second cancel signal by converting the second signal, which is generated by the second filter unit 162C, to a digital signal. The second cancel signal is applied to a second noise voice coil 181B, which will be described later, in the second drive unit 18B.

The first filter unit 161C and the first ADC 164C constitute a first circuit of the present invention. The second filter unit 162C and the second ADC 165C constitute a second circuit of the present invention. The first circuit and the second circuit serve as a filter unit of the present invention for analog processing of the noise signal.

The third drive unit 19 generates sound waves based on the cancel signal (the first cancel signal) and outputs them to the front air chamber A1. The third drive unit 19 is attached to a baffle plate (not shown in the drawing) and disposed in the housing 11. The third drive unit 19 includes the first noise voice coil 191, a third voice coil bobbin (not shown in the drawing), a third diaphragm 193, and a third magnetic circuit (not shown in the drawing).

The first noise voice coil 191 is driven by the first cancel signal from the NC circuit 16C and vibrates the third diaphragm 193 in accordance with the first cancel signal. The first noise voice coil 191 is attached to the third diaphragm 193 and is wound around the third voice coil bobbin disposed in the magnetic gap (not shown in the drawing) of the third magnetic circuit.

The third diaphragm 193 vibrates in response to the vibration of the first noise voice coil 191 and generates and outputs sound waves. The third diaphragm 193 can vibrate with respect to the third magnetic circuit.

The third magnetic circuit and the second magnetic circuit have a common configuration. The first noise voice coil 191 is disposed in the magnetic gap so as to cross the magnetic flux. The first noise voice coil 191 vibrates with respect to the third magnetic circuit through the electromagnetic force generated by the first cancel signal applied to the first noise voice coil 191. Consequently, the third diaphragm 193 generates sound waves corresponding to the first cancel signal and outputs them to the front air chamber A1.

Next, the operation of the present apparatus 1C according to the fourth embodiment will be described with reference to FIG. 5 taking the operation of the first sound output unit 10C as an example.

The operations of the input unit 13, the signal processing circuit 15, and the first drive unit 17 are the same as the operations of the input unit 13, the signal processing circuit 15, and the first drive unit 17 according to the first embodiment, respectively.

The first filter unit 161C generates a first signal based on the first noise signal from the FF microphone 141. The first ADC 164C generates a first cancel signal by converting the first signal to a digital signal.

In other words, the first circuit generates a first cancel signal based on the first noise signal. The first cancel signal is amplified by a digital amplifier (not shown in the drawing) and is applied to the first noise voice coil 191 of the third drive unit 19.

The second filter unit 162C generates a second signal based on the second noise signal from the FB microphone 142. The second ADC 165C generates a second cancel signal by converting the second signal to a digital signal.

In other words, the second circuit generates a second cancel signal based on the second noise signal. The second cancel signal is amplified by a digital amplifier (not shown in the drawing) and is applied to the second noise voice coil 181B of the second drive unit 18B.

The generation of the cancel signals (the first cancel signal and the second cancel signals) in the NC circuit 16C is analog processing that does not involve digital processing by a DSP or the like. Hence, the present apparatus 1C requires less time to generate the cancel signal than the conventional apparatus. In other words, the cancel signal generated by the present apparatus 1C is less delayed than the cancel signal generated by the conventional apparatus.

The sound voice coil 171 vibrates with the electromagnetic force generated through a relationship between the applied digital processing signal and the magnetic flux in the magnetic gap. The first noise voice coil 191 vibrates with the electromagnetic force generated through a relationship between the applied first cancel signal and the magnetic flux in the magnetic gap. The second noise voice coil 181B vibrates with the electromagnetic force generated through a relationship between the applied second cancel signal and the magnetic flux in the magnetic gap.

The first diaphragm 173 vibrates with the vibration of the sound voice coil 171, the second diaphragm 183B vibrates with the vibration of the second noise voice coil 181B, and the third diaphragm 193 vibrates with the vibration of the first noise voice coil 191. Consequently, the sound waves output from the first diaphragm 173 are acoustically synthesized with the sound waves output from the second diaphragm 183B and sound waves output from the third diaphragm 193 within the front air chamber A1.

As described above, the first drive unit 17 is a drive unit solely for sound that outputs sound based on the digital processing signal, and the second drive unit 18B and the third drive unit 19 are drive units dedicated to noise cancellation that output a cancel sound based on the cancel signal.

In other words, the present apparatus 1C according to the fourth embodiment does not require an adder circuit for adding the digital processing signal and the cancel signal together by digital processing. Hence, the cancel signal generated by the present apparatus 1C is not affected by the phase characteristics of the adder circuit.

Consequently, the phase of the first cancel signal generated by the present apparatus 1C does not change between the NC circuit 16C and the first noise voice coil 191. Similarly, the phase of the second cancel signal generated by the present apparatus 1C does not change between the NC circuit 16C and the second noise voice coil 181B.

The first cancel signal in the present apparatus 1C is applied to the first noise voice coil 191 without being added to the second cancel signal. Therefore, the first noise voice coil 191 is not affected by the sound components that may be included in the second cancel signal (the sound components remaining without being removed by the second filter unit 162C).

In addition, the second cancel signal is applied to the second noise voice coil 181B without being added to the first cancel signal. For this reason, the second noise voice coil 181B is not affected by the first cancel signal.

Consequently, the third drive unit 19 of the present apparatus 1C vibrates more faithfully to the first cancel signal than the second drive unit 18 of the first embodiment. Further, the second drive unit 18B of the present apparatus 1C vibrates more faithfully to the second cancel signal (the second signal) than the second drive unit 18 of the first embodiment. In other words, the present apparatus 1C achieves a noise cancellation effect faithful to the cancel signals (the first cancel signal and the second cancel signal) compared with the present apparatus 1 of the first embodiment.

According to the fourth embodiment described above, in the present apparatus 1C, the digital processing signal is applied to the first drive unit 17, the first cancel signal is applied to the third drive unit 19, and the second cancel signal is applied to the second drive unit 18B.

Thus, like the present apparatus 1 of the first embodiment, the present apparatus 1C is less prone to a delay of the cancel signal or a change in the phase of the cancel signal than the conventional apparatus. In other words, the present apparatus 1C contributes to a reduction in a difference between the phase of the cancel signal and the phase opposite to that of noise, compared with the conventional apparatus.

Further, the present apparatus 1C includes a first noise voice coil 191 dedicated to the first cancel signal, and a second noise voice coil 181B dedicated to the second cancel signal. Consequently, like the present apparatus 1A of the second embodiment, the present apparatus 1C achieves a noise cancellation effect faithful to the cancel signals (the first cancel signal and the second cancel signal) compared with the present apparatus 1 of the first embodiment.

Note that, in the fourth embodiment, the NC circuit 16C of the present invention does not necessarily include the first ADC 164C or the second ADC 165C. In other words, the NC circuit 16C may apply a cancel signal, which is an analog signal, to the first noise voice coil 191 of the third drive unit 19 or the second noise voice coil 181B of the second drive unit 18B.

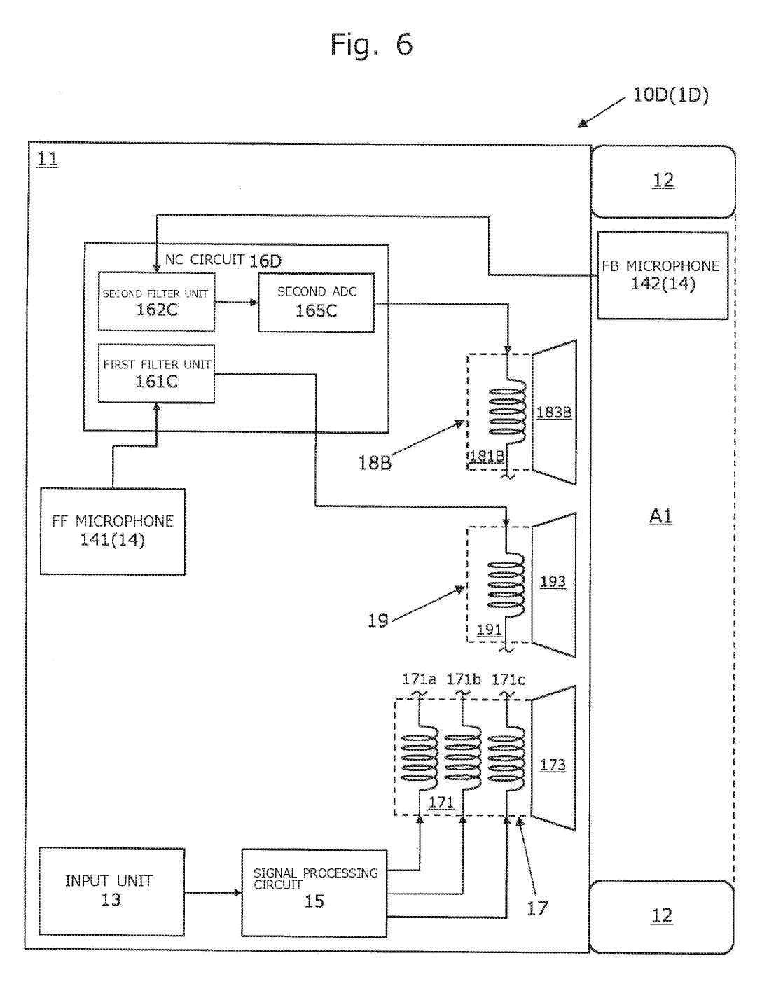

A fifth embodiment of the present apparatus will now be described with reference to FIG. 6. FIG. 6 is a schematic view showing only the configuration of a first sound output unit 10D included in this present apparatus 1D. In the drawing, a member denoted by the same reference numeral as in another drawing has the same function as the corresponding member in the other drawing.

The configuration of the present apparatus 1D is the same as the configuration of the present apparatus 1C of the fourth embodiment except that the NC circuit 16D does not include the first ADC.

In the fifth embodiment, the NC circuit 16D applies the first signal from the first filter unit 161C to the first noise voice coil 191 as a first cancel signal. In other words, the NC circuit 16D generates a first cancel signal, which is an analog signal, and a second cancel signal, which is a digital signal.

In other words, the NC circuit 16D generates the first cancel signal, which is an analog signal, based on the first noise signal from the FF microphone 141 and supplies it to the first noise voice coil 191, and generates the second cancel signal, which is a digital signal, based on the second noise signal from the FB microphone 142 and supplies it to the second noise voice coil 181B.

Note that a modification can be made in which not the first ADC but only the second ADC 165C is excluded from the NC circuit 16D. In other words, the first cancel signal, which is a digital signal, may be generated based on the first noise signal from the FF microphone 141 and supplied to the first noise voice coil 191, and the second cancel signal, which is an analog signal, may be generated based on the second noise signal from the FB microphone 142 and supplied to the second noise voice coil 181B.

Further, an NC circuit of the present invention is not necessarily provided with an ADC (the first ADC or the second ADC). In other words, the NC circuit may generate cancel signals (the first cancel signal and the second cancel signal), which are analog signals, and may apply the cancel signals to noise voice coils (the first noise voice coil and the second noise voice coil).

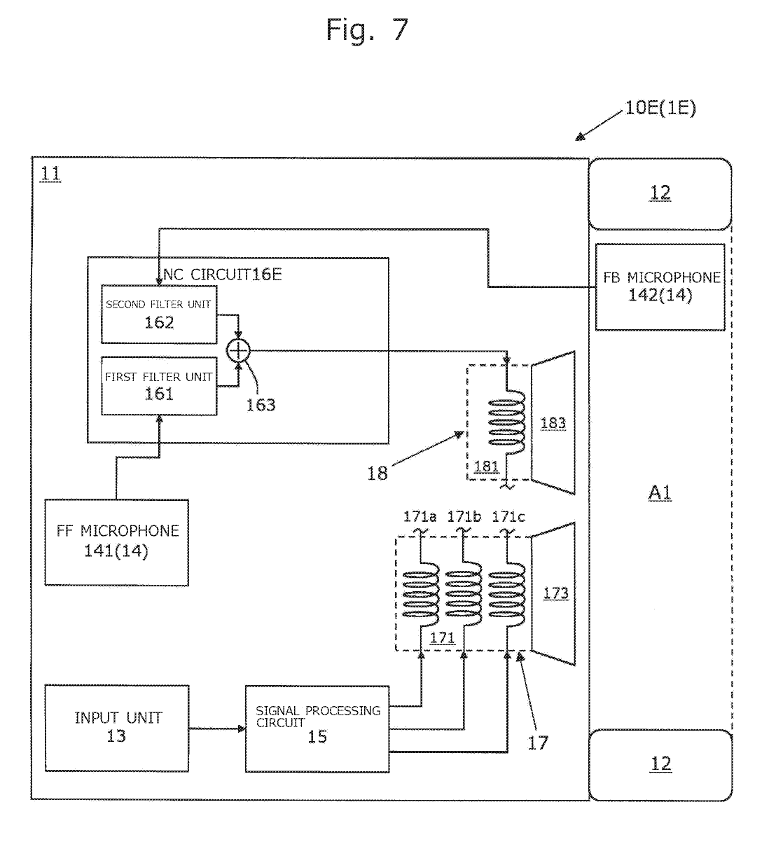

A sixth embodiment of the present apparatus will now be described with reference to FIG. 7. FIG. 7 is a schematic view showing only the configuration of a first sound output unit 10E included in this present apparatus 1E. In the drawing, a member denoted by the same reference numeral as in another drawing has the same function as the corresponding member in the other drawing.

The configuration of the present apparatus 1E is the same as the configuration of the present apparatus 1 of the first embodiment except that an NC circuit 16E does not include an ADC.

In the sixth embodiment, the NC circuit 16E generates a cancel signal, which is an analog signal, by adding the first signal from the first filter unit 161 and the second signal from the second filter unit 162 together in the adder unit 163.

This cancel signal is amplified by an analog signal amplifier (not shown in the drawing) and is applied to the noise voice coil 181 of the second drive unit 18. In other words, in the present apparatus 1E, the first drive unit 17 is driven by a digital signal (digital processing signal), and the second drive unit 18 is driven by an analog signal (cancel signal). Consequently, the present apparatus 1E does not require an ADC or a digital amplifier and can be made smaller at a lower cost than the present apparatus 1 of the first embodiment.

In addition, for the NC circuit in the first to sixth embodiments described above, the signal level of the first cancel signal may be different from the signal level of the second cancel signal. In other words, for the NC circuit in the present apparatus, a relative difference (level difference) between the two signal levels may be set.

For example, the level of the first cancel signal is set higher than the level of the second signal. In this case, noise is canceled mainly by the feedforward canceling function, and the feedback noise canceling function is used as an aid of the feedforward canceling function. This suppresses the influence of the sound components that may be included in the second cancel signal on the first cancel signal.

In addition, the NC circuit according to the first to sixth embodiments described above may generate a second cancel signal solely for low-frequency noise. For example, a second cancel signal suppressing only noise with a frequency lower than that of the sound from the sound source may be generated.

This suppresses the influence of the sound components that may be included in the second cancel signal on the first cancel signal. In addition, since the earpad has a passive noise canceling function for suppressing the noise with a middle-to-high frequency, the noise entering the front air chamber through the ear pad is low-frequency noise. Therefore, the present apparatus provides an excellent noise cancellation effect while suppressing the influence of the sound components that may be included in the second cancel signal on the first cancel signal.

Further, the number of individual sound voice coils included in a sound voice coil is not limited to “3”. In other words, four individual sound voice coils or a single individual sound voice coil may be included therein.

1. A digital electroacoustic transducer apparatus comprising:
a signal processing circuit that generates a digital processing signal based on a digital signal from a sound source;
a first drive unit that receives the digital processing signal;
a sound pickup unit that picks up noise and generates a noise signal;
a noise canceling circuit that generates a cancel signal based on the noise signal; and
a second drive unit that receives the cancel signal.

2. The digital electroacoustic transducer apparatus according to claim 1, wherein
the first drive unit comprises:
a sound voice coil that receives the digital processing signal; and
a first diaphragm to which the sound voice coil is attached, and
the second drive unit comprises:
a noise voice coil that receives the cancel signal; and
a second diaphragm to which the noise voice coil is attached.

3. The digital electroacoustic transducer apparatus according to claim 2, wherein
the sound voice coil comprises a plurality of individual sound voice coils,
the digital processing signal comprises a plurality of individual digital processing signals that are respectively different from each other, and
the plurality of individual digital processing signals is applied to the respective individual sound voice coils.

4. The digital electroacoustic transducer apparatus according to claim 1, wherein
the sound pickup unit comprises:
a first microphone that picks up the noise and generates a first noise signal; and
a second microphone that picks up the noise and generates a second noise signal,
the noise canceling circuit comprises:
a first circuit that generates, as the cancel signal, a first cancel signal based on the first noise signal; and
a second circuit that generates, as the cancel signal, a second cancel signal based on the second noise signal, and
the first cancel signal and the second cancel signal are applied to the second drive unit.

5. The digital electroacoustic transducer apparatus according to claim 4, wherein
the first drive unit comprises:
a sound voice coil that receives the digital processing signal; and
a first diaphragm to which the sound voice coil is attached, and
the second drive unit comprises:
a first noise voice coil that receives the first cancel signal;
a second noise voice coil that receives the second cancel signal; and
a second diaphragm to which the first noise voice coil and the second noise voice coil are attached.

6. The digital electroacoustic transducer apparatus according to claim 4, wherein the noise canceling circuit applies the cancel signal obtained by adding the first cancel signal and the second cancel signal together, to the second drive unit.

7. The digital electroacoustic transducer apparatus according to claim 1, wherein
the sound pickup unit comprises:
a first microphone that picks up the noise and generates a first noise signal; and
a second microphone that picks up the noise and generates a second noise signal,
the noise canceling circuit comprises:
a first circuit that generates, as the cancel signal, a first cancel signal based on the first noise signal; and
a second circuit that generates, as the cancel signal, a second cancel signal based on the second noise signal,
the first cancel signal is applied to the first drive unit, and
the second cancel signal is applied to the second drive unit.

8. The digital electroacoustic transducer apparatus according to claim 6, wherein
the first drive unit comprises:
a sound voice coil that receives the digital processing signal;
a first noise voice coil that receives the first cancel signal; and
a first diaphragm to which the sound voice coil and the first noise voice coil are attached, and
the second drive unit comprises:
a second noise voice coil that receives the second cancel signal, and
a second diaphragm to which the second noise voice coil is attached.

9. The digital electroacoustic transducer apparatus according to claim 1, further comprising a third drive unit, wherein
the sound pickup unit comprises:
a first microphone that picks up the noise and generates a first noise signal; and
a second microphone that picks up the noise and generates a second noise signal,
the noise canceling circuit comprises:
a first circuit that generates, as the cancel signal, a first cancel signal based on the first noise signal; and
a second circuit that generates, as the cancel signal, a second cancel signal based on the second noise signal,
the first cancel signal is applied to the third drive unit, and
the second cancel signal is applied to the second drive unit.

10. The digital electroacoustic transducer apparatus according to claim 9, wherein
the first drive unit comprises:
a sound voice coil that receives the digital processing signal; and
a first diaphragm to which the sound voice coil is attached,
the second drive unit comprises:
a second noise voice coil that receives the second cancel signal; and
a second diaphragm to which the second noise voice coil is attached, and
the third drive unit comprises:
a first noise voice coil that receives the first cancel signal; and
a third diaphragm to which the first noise voice coil is attached.

11. The digital electroacoustic transducer apparatus according to claim 4, wherein a signal level of the first cancel signal is different from a signal level of the second cancel signal.

12. The digital electroacoustic transducer apparatus according to claim 1, wherein
the noise canceling circuit comprises:
a filter unit for analog processing of the noise signal; and
a converter that converts an analog signal produced by processing in the filter unit, to a digital signal.

13. The digital electroacoustic transducer apparatus according to claim 4, wherein
the first microphone is a feedforward microphone, and
the second microphone is a feedback microphone.

14. The digital electroacoustic transducer apparatus according to claim 7, wherein
the first microphone is a feedforward microphone, and
the second microphone is a feedback microphone.

15. The digital electroacoustic transducer apparatus according to claim 9, wherein
the first microphone is a feedforward microphone, and
the second microphone is a feedback microphone.
